(19) United States
(12) Patent Application Publication
(10) Pub. No.: US 2008/0055504 A1
(43) Pub. Date: Mar. 6, 2008

(54) Making dual side displays

(76) Inventors: Jin Young Choi, Seoul (KR); Yong Han Park, Hwaseong (KR); Kee Han Uh, Yongin (KR); Jin Jeon, Anyang (KR)

Correspondence Address: MACPHERSON KWOK CHEN & HEID LLP, 2033 GATEWAY PLACE, SUITE 400, SAN JOSE, CA, 95110, US

(21) Appl. No.: 11/888,786

(22) Filed: Aug. 1, 2007

(30) Foreign Application Priority Data
Aug. 1, 2006 (KR) 10-2006-0072726

(51) Int. Cl. G02F 1/13357; G02F 1/13; G02F 1/1333; G02F 1/136; G02F 1/1335

(52) U.S. Cl. 349/38; 349/114; 349/43; 349/95; 438/30

(57) ABSTRACT

A dual side display includes reflection and transmission pixels for displaying an image on both sides of the display. A reflection film provided in a reflection pixel region is extended up to a transmission storage capacitor formation region of a transmission pixel such that the aperture ratio of the reflection pixel is enhanced. An upper storage electrode connected to a transmission storage line is formed between the reflection film and a lower storage electrode of the transmission storage capacitor to prevent a coupling phenomenon between the reflection film and the lower storage electrode and a resulting signal distortion.

### RELATED APPLICATIONS

This application claims priority of Korean Patent application No. 10-2006-0072726, filed Aug. 1, 2006, the entire disclosure of which is incorporated herein by reference.

### BACKGROUND

This disclosure relates to dual side displays that are capable of displaying an image on both sides thereof and methods for making them, and more particularly, to dual side displays having pixels with enhanced aperture ratios and methods for making them.

Dual side displays are display devices that produce images on both sides thereof. Heretofore, such dual side displays have been manufactured by positioning a light source between two separate flat display panels arranged back-to-back. That is, one flat display panel is positioned at a front side of the display and another flat panel display is positioned at a rear side thereof, so that users can view images respectively produced by the panels at both front and rear sides thereof.

Recently, techniques have been suggested for making dual side displays in which images can be seen at both sides of the display using a single flat display panel. For example, a dual side display can be made by positioning respective transparent backlights at front and rear sides thereof, respectively. That is, the rear backlight is driven to enable a user to view an image on the front side of the display, whereas, the front backlight is driven to enable the user to view an image on the rear side thereof, so that the user can view images on both sides of the display.

In another embodiment, a dual side display can be made by dividing the pixels thereof into transmission and reflection type pixels. In this embodiment, light from a light source passes through the transmission pixels such that an image is displayed on a plane opposite to the region at which the light source is positioned, whereas, light from the light source is reflected by the reflection pixel such that an image is displayed on a plane in the region at which the light source is positioned. However, dividing the pixels of a single flat panel display panel into transmission and reflection pixels creates a problem, in that the aperture ratio of the reflection pixel region is relatively low, and the visibility of an image in the reflection pixel region is therefore reduced.

### BRIEF SUMMARY

In accordance with the exemplary embodiments thereof described herein, the present invention provides dual side displays and methods for making them in which the reflection region of the reflection pixels of the display extend to a transmission storage capacitor region of the transmission pixels thereof so that the aperture ratio of the reflection pixels is thereby substantially enhanced, and the signal distortion between the transmission and reflection pixels is thereby eliminated.

In one exemplary embodiment, a display comprises a transmission pixel having a transmission pixel capacitor and a transmission storage capacitor, a reflection pixel having a reflection pixel capacitor and a reflection storage capacitor, and a reflection film formed at a region of the reflection pixel, wherein a portion of the reflection film extends so as to overlap a portion of the transmission storage capacitor.

The transmission pixel capacitor preferably includes a transmission pixel electrode, a common electrode and a liquid crystal layer interposed between the electrodes, and the reflection pixel capacitor includes a reflection pixel electrode, a common electrode and a liquid crystal layer interposed between the electrodes. In this embodiment, the reflection film is preferably formed on a top or a bottom surface of the reflection pixel electrode.

The transmission storage capacitor preferably includes a lower storage electrode connected to both the transmission pixel electrode and an upper storage electrode provided above the lower storage electrode. More preferably, the transmission pixel further includes a transmission storage line, and the transmission line and the upper storage electrode are connected to each other.

The lower storage electrode and the transmission storage line are preferably provided in the same plane. Further, the reflection film may overlap a region at which the lower and upper storage electrodes overlap each other.

The display may further comprise a transmission thin film transistor (TFT) for supplying a first image signal to the transmission pixel capacitor, and a reflection TFT for supplying a second image signal to the reflection pixel capacitor.

In another exemplary embodiment, a display comprises a plurality of transmission and reflection gate lines extending in an abscissa direction, a plurality of data lines extending in an ordinate direction, transmission pixels provided at some regions in which the transmission gate lines and the data lines intersect each other, reflection pixels provided at other regions in which the reflection gate lines and the data lines intersect each other, and reflection films formed at the regions of the reflection pixels. Each of the transmission pixels includes a transmission TFT connected to the transmission gate line and the data line, a transmission pixel capacitor connected to the transmission TFT, and a transmission storage capacitor. Each of the reflection pixels includes a transmission TFT connected to the reflection gate line and the data line, a reflection pixel capacitor connected to the reflection TFT, and a reflection storage capacitor, and a portion of the reflection film extends to overlap a portion of the transmission storage capacitor.

In this exemplary embodiment, the reflection pixel capacitor may include a reflection pixel electrode connected to a drain electrode of the reflection TFT, a common electrode spaced apart from the reflection pixel electrode, and a liquid crystal layer provided in a spaced region between the reflection pixel electrode and the common electrode. Preferably, the reflection film is formed on a top or a bottom surface of the reflection pixel electrode. More preferably, the transmission gate line is provided below the reflection pixel electrode.

In this embodiment, the transmission storage capacitor may include a lower storage electrode connected to a drain electrode of the transmission TFT and an upper storage electrode provided above the lower storage electrode. The display may further comprise transmission storage lines extending in parallel with the transmission gate lines. Preferably, the transmission storage line is connected to the upper storage electrode of the transmission storage capacitor including the upper and lower storage electrodes. Preferably, the reflection storage capacitor includes a reflection storage line extending in parallel with the reflection gate line, and an upper electrode provided above the reflection storage line and connected to the drain electrode of the reflection TFT. More preferably, the upper electrode is provided below the reflection pixel electrode.

The transmission and reflection gate lines may be disposed in an alternately arrangement.

Preferably, the transmission TFT supplies a first image signal to the transmission pixel capacitor and the transmission storage capacitor, and the reflection TFT supplies a second image signal to the reflection pixel capacitor and the reflection storage capacitor. More preferably, each of the transmission and reflection TFTs is turned on during an H/2 period and a light source is provided above the reflection film.

In another exemplary embodiment, a display comprises lower and upper substrates. The lower substrate includes a plurality of transmission and reflection gate lines extending in an abscissa direction, data lines extending in an ordinate direction, transmission and reflection storage lines extending respectively in parallel with the transmission and reflection gate lines, transmission TFTs connected to the transmission gate lines and the data lines, reflection TFTs connected to the reflection gate lines and the data lines, lower storage electrodes spaced from the transmission storage lines and connected to the transmission TFTs, upper storage electrodes provided above the lower storage electrodes and connected to the transmission storage lines, reflection pixel electrodes provided above the reflection storage lines and connected to reflection TFTs, reflection films formed on top or bottom surfaces of the reflection pixel electrodes and partially overlapping regions in which the lower and upper storage electrodes overlap each other, and transmission pixel electrode electrically connected to the lower storage electrodes through the transmission TFTs and spaced apart from the reflection pixel electrodes

The upper substrate includes common electrodes corresponding to the transmission and reflection pixel electrodes, and a liquid crystal layer interposed between the lower and upper substrates. The transmission storage line is preferably connected to the upper storage electrode through a first contact hole, and the lower storage electrode is connected to a drain electrode of the transmission TFT through a second contact hole.

The reflection film may incorporate an irregular form.

The display may further comprise an upper electrode connected to the reflection pixel electrode and a drain electrode of the transmission TFT between the reflection pixel electrode and the reflection storage line.

In another exemplary embodiment, a method for manufacturing a display comprises respectively forming: Transmission and reflection gate lines, transmission and reflection storage lines, and a lower storage electrode on a substrate; a transmission TFT connected to the transmission gate line and the lower storage electrode, an upper storage electrode overlapping the lower storage electrode and connected to the transmission storage line, a reflection TFT connected to the reflection gate line, and a data line connected to the transmission and reflection TFTs; a protection film on an entire substrate structure; a transmission pixel electrode connected to the lower storage electrode through the transmission TFT, and a reflection pixel electrode connected to the reflection TFT and electrically insulated from the transmission pixel electrode; and, a reflection film provided on the reflection pixel electrode and partially overlapping a region in which the lower and upper storage electrodes overlap each other.

Before the formation of the protection film on the entire structure, the exemplary method may further include: Forming an insulation film over the entire structure, including the transmission and reflection gate lines and the lower storage electrode; removing a portion of the insulation film to form a contact hole through which a portion of the lower storage electrode is exposed; and, forming a drain electrode of the transmission TFT to extend into the contact hole.

The method may further comprise removing the protection film above the contact hole to form a pixel contact hole, and forming the transmission pixel electrode to extend into the pixel contact hole.

Alternatively, before the formation of the protection film on the entire structure, the method may include: Forming an insulation film on the entire structure including the transmission and reflection gate lines and the transmission storage line; removing a portion of the insulation film to form a contact hole through which a portion of the transmission storage line is exposed; and forming the upper storage electrode to extend into the contact hole.

Preferably, an irregular pattern is formed on a surface of the protection film at a region in which the reflection pixel electrode or the reflection film is formed.

In another exemplary embodiment, a display comprises a plurality of gate lines extending in an abscissa direction, a plurality of data lines extending in an ordinate direction, TFTs provided at regions in which the gate and data lines intersect each other, storage lines extending in parallel with the gate lines, lower storage electrodes connected to the TFTs, upper storage electrodes formed above the lower storage electrodes and connected to the storage lines, pixel electrodes connected to the TFTs and provided at the regions in which the gate and data lines intersect each other, common electrodes spaced apart from the pixel electrodes, and a liquid crystal layer provided in a space between the pixel electrodes and the common electrodes.

In this embodiment, the gate line, the storage line and the lower storage electrode are preferably formed in the same plane, i.e., are coplanar with each other.

A better understanding of the above and many other features and advantages of the novel dual side displays and the methods for making them of the present invention may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is a partial top plan view of an exemplary embodiment of a dual side display panel in accordance with the present invention, showing an exemplary single pixel area thereof;

FIGS. 2A-A and 2B-B are partial cross-sectional views of the dual side display panel of FIG. 1, as respectively seen along the lines of the sections A-A and B-B taken therein;

FIG. 3 is a partial cross-sectional view of the dual side display panel of FIG. 1, as seen along the lines of the section C-C taken therein;

FIGS. 4(a) and 4(b) are plan views illustrating respective features of the exemplary dual side display panel; and,

FIGS. 5 to 9 are partial top plan and associated cross-sectional views of the panel respectively illustrating successive stages of an exemplary embodiment of a method for manufacturing the dual side display panel in accordance with the present invention.

### DETAILED DESCRIPTION

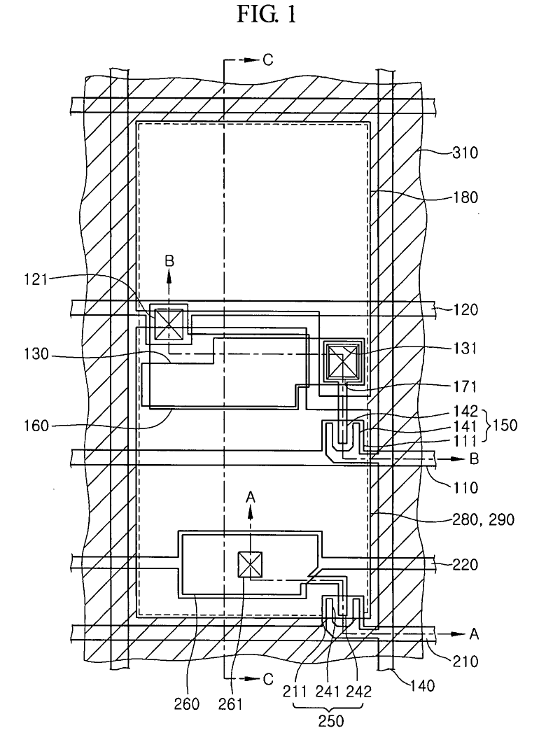

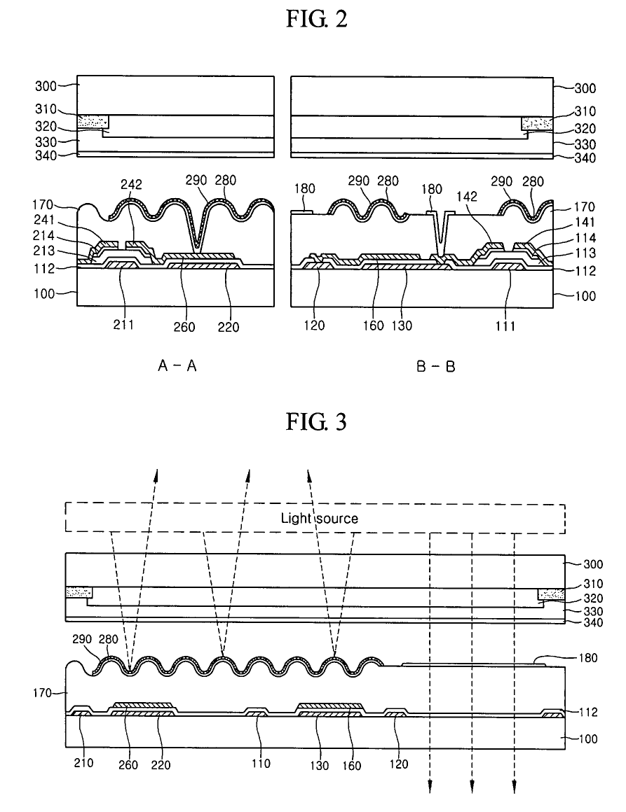

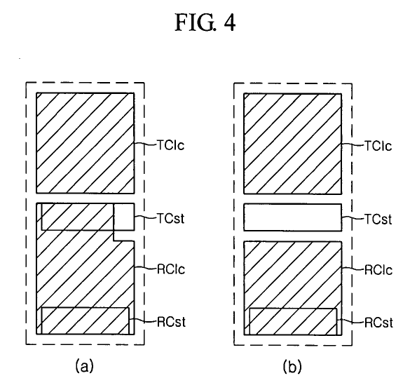

FIG. 1 is a partial top plan view of an exemplary embodiment of a dual side display panel in accordance with the present invention, showing an exemplary single pixel area thereof. FIGS. 2A-A and 2B-B are partial cross-sectional views of the panel, as seen along the lines of the respective sections A-A and B-B taken in FIG. 1. FIG. 3 is a partial cross-sectional view of the panel, as seen along the lines of the section C-C taken in FIG. 1, and FIGS. 4(a) and 4(b) are plan views illustrating respective features of the exemplary dual side display panel discussed below.

Referring to FIGS. 1 to 4, the exemplary dual side display panel comprises a plurality of transmission and reflection gate lines 110 and 210 extending in an abscissa direction, a plurality of data lines 140 extending in an ordinate direction, and transmission and reflection pixels provided at respective regions of intersection of the transmission and reflection gate lines 110 and 210 and the data lines 140.

The transmission pixel comprises a transmission pixel capacitor TClc, a transmission storage capacitor TCst and a transmission thin film transistor (TFT) 150, whereas, the reflection pixel comprises a reflection film 290, a reflection pixel capacitor RClc, a reflection storage capacitor RCst and a reflection TFT 250. At least the reflection film 290 extends up to an upper region of the transmission storage capacitor TCst in the transmission pixel. The transmission and reflection pixels each display different image information.

A plurality of transmission and reflection gate lines extend in the abscissa direction and are arranged in an alternating manner. The transmission gate line 110 is connected to the transmission TFT 150, and the reflection gate line 210 is connected to the reflection TFT 250. A plurality of data lines 140 extend in the ordinate direction and are connected to the transmission and reflection TFTs 150 and 250, respectively. One transmission pixel and one reflection pixel, respectively defined at a region of intersection of one transmission gate line 110, one reflection gate line 210 and one data line 140, form a single pixel.

The transmission pixel capacitor TClc comprises a transmission pixel electrode 180, a common electrode 340 and a liquid crystal layer interposed between the two electrodes. The reflection pixel capacitor RClc comprises a reflection pixel electrode 280, a common electrode 340 and a liquid crystal layer interposed between the two electrodes. In the particular embodiment illustrated, the reflection film 290 is formed on the reflection pixel electrode 280. However, the reflection film 290 may also be formed below the reflection pixel electrode 280.

The transmission TFT 150 comprises a gate electrode 111 connected to the transmission gate line 110, a source electrode 141 connected to the data line 140, and a drain electrode 142 connected to the transmission pixel electrode 180. The reflection TFT 250 comprises a gate electrode 211 connected to the reflection gate line 210, a source electrode 241 connected to the data line 140, and a drain electrode 242 connected to the reflection pixel electrode 280.

The transmission storage capacitor TCst comprises a lower storage electrode 130 electrically connected to the transmission pixel electrode 180 and an upper storage electrode 160 electrically connected to a transmission storage line 120. The transmission pixel electrode 180 and the lower storage electrode 160 are electrically connected through a plurality of contacts. The reflection storage capacitor RCst comprises an upper electrode 260 that is electrically connected to the reflection pixel electrode 280 and a reflection storage line 220. In the particular embodiment illustrated, a portion of the reflection storage line 220 protrudes outwardly in the shape of a plate corresponding to the upper electrode 260, as shown in the figures.

In the particular embodiment illustrated, light from a light source disposed above the display (dashed outline of FIG. 3) is reflected from a region in which the reflection pixel capacitor RClc and the reflection film 290 are provided, so that an image is displayed on a top surface of the display panel, as shown in FIG. 3. Further, light from the upper light source is transmitted to a region in which the transmission pixel capacitor TClc is provided, so that an image is displayed on a bottom surface of the display panel. That is, the respective transmission and reflection pixels operate independently of each other.

The operation of the transmission pixel is as follows. When a gate-on signal is applied to the transmission gate line 110, the transmission TFT 150 is turned on to supply a first image signal of the data line 140 to the transmission pixel electrode 180 and the lower storage electrode 130. An electric field between both ends of the transmission pixel capacitor TClc changes, due to a first pixel signal supplied to the transmission pixel electrode 180, which comprises one electrode terminal of the transmission pixel capacitor TClc, so that the molecular arrangement of the liquid crystal layer disposed between the electrodes is changed accordingly. The amount of light from the light source above the top surface of the display panel that is transmitted through the liquid crystal layer as a result of such change in molecular arrangement is controlled such that an image is displayed on the bottom surface of the panel.

The operation of the reflection pixel is as follows. When a gate-on signal is applied to the reflection gate line 210, the reflection TFT 250 is turned on to supply a second image signal of the data line 140 to the reflection pixel electrode 280. An electric field between both ends of the reflection pixel capacitor RClc changes due to a second pixel signal supplied to the reflection pixel electrode 280, which comprises one electrode terminal of the reflection pixel capacitor RClc, so that the molecular arrangement of the liquid crystal layer disposed between the electrodes is changed accordingly. As described above, the reflection film 290 is provided on the reflection pixel electrode 280. Therefore, light from the light source is not transmitted through the display panel, but instead, is reflected back toward the top surface thereof by the reflection film 290. Accordingly, the amount of light transmitted from the light source to the reflection film 290 and the amount of light that is reflected back from the reflection film 290 is controlled through the change in arrangement of the molecules of the liquid crystal layer such that an image is displayed on the top surface of the display panel.

In accordance with the foregoing, the exemplary display panel enables an image to be displayed on both the top and bottom surfaces thereof. In the particular embodiment illustrated, it is preferred that the light source be positioned on the top surface of the display panel, as described above. Also, a transparent light source is preferably used as the light source to display an image through a plane in which the light source is located. Further, in this embodiment, the first and second pixel signals are supplied respectively to the transmission and reflection pixels through a single data line 140. Additionally, it is preferable that the first and second pixel signals be supplied to the single data line 140 through a time division method. That is, the first and second pixel signals are both respectively supplied to the transmission and reflection pixels during a 1H period. Thus, the transmission TFT 150 of the transmission pixel is driven to supply the first pixel signal to the transmission pixel capacitor TClc during a first H/2 period, and the reflection TFT 250 of the reflection pixel is driven to supply the second pixel signal to the reflection pixel capacitor RClc during a second H/2 period. Of course, the present invention is not limited to this particular method, and various other driving methods can be applied. For example, only the reflection pixel may be driven when a user views the top surface of the display panel, and only the transmission pixel may be driven when the user views the bottom surface of the display panel.

In this embodiment, the reflection pixel electrode 280 of the reflection pixel capacitor RClc and the reflection film 290 formed thereon extend up to a portion of an upper region of the transmission storage capacitor TCst, so that the aperture ratio of the reflection pixel is thereby enhanced.

Since the transmission storage capacitor TCst is fabricated with an opaque film, this results in a reduction in the transmittance of the transmission pixel in an embodiment in which the transmission storage capacitor TCst and the transmission pixel capacitor TClc overlap each other. Therefore, it is preferred that the transmission pixel capacitor TClc and the transmission storage capacitor TCst do not spatially overlap each other, as illustrated in FIG. 4. The reflection storage capacitor RCst is also fabricated with an opaque film. However, since the reflection film 290 is formed on the reflection storage capacitor RCst, the transmittance of the reflection pixel is not reduced even though the reflection pixel capacitor RClc and the reflection storage capacitor RCst overlap each other. Thus, the reflection storage capacitor RCst and the reflection pixel capacitor RClc are formed to spatially overlap each other, as shown in FIG. 4. Then, the reflection pixel capacitor RClc and/or the reflection film 290 extend up to an upper region of the opaque transmission storage capacitor TCst so that the reflectance of the reflection pixel is thereby enhanced, as described above, and accordingly, the transmittance of the transmission pixel is not reduced.

That is, where an area of the reflection pixel capacitor RClc is expanded in such a manner that the transmission storage capacitor TCst and the reflection pixel capacitor RClc partially overlap each other, as illustrated in FIG. 4(a), the reflectance is increased by about 5 to 20% or more, as compared to when an area of the reflection pixel capacitor RClc is not expanded, as illustrated in FIG. 4(b). This means that the aperture ratio in the plane in which an image is displayed by the reflection pixel is increased by 2 to 20% or more. As an example of this, a 2.22-inch display panel is described. In the case of a display panel with a pixel structure as shown in FIG. 4(b), the transmittance in the plane in which an image is displayed by a transmission pixel is 34%, and the reflectance the plane in which an image is displayed by a reflection pixel is approximately 34%. However, in the case of a display panel with a pixel structure as shown in FIG. 4(a), the transmittance in the plane in which an image is displayed by a transmission pixel remains the same, i.e., approximately 34%, but the reflectance in the plane in which an image is displayed by a reflection pixel is enhanced to 38%. Accordingly, the reflectance of the plane in which an image is displayed by the reflection pixel is enhanced by about 10%, so that the visibility of the plane in which the image is displayed by the reflection pixel is correspondingly enhanced.

Further, in this particular embodiment, the upper storage electrode 160 that is electrically connected to the transmission storage line 120 is positioned between the reflection pixel electrode 280 of the reflection pixel capacitor RClc and the lower storage electrode 130 of the transmission storage capacitor TCst that is electrically connected to the transmission pixel electrode 180 of the transmission pixel capacitor TClc. This prevents the occurrence of a coupling phenomenon between the reflection pixel electrode 280 and the lower storage electrode 130. That is, since different grayscale voltages (i.e., the first and second pixel signals described above) are applied to the reflection pixel electrode 280 and the lower storage electrode 130, respectively, signal distortion may occur, due to the coupling phenomenon when the grayscale voltages overlap each other. However, if the upper storage electrode 160 to which a common voltage is applied is positioned in a region between the reflection pixel electrode 280 and the lower storage electrode 130 as described above, this prevents the coupling phenomenon from occurring between the two electrodes, thereby preventing signal distortion.

According to the exemplary embodiments of the present invention herein, the transmission and reflection gate lines 110 and 210, the data lines 140, the transmission and reflection TFTs 150 and 250, the transmission and reflection storage capacitors TCst and RCst, and the transmission and reflection pixel electrodes 180 and 280 of the transmission and reflection pixel capacitors TClc and RClc are all formed on a lower substrate 100, whereas, the common electrode 340 of the transmission and reflection pixel capacitors TClc and RClc are formed on an upper substrate 300. Further, the liquid crystal layer is interposed between the lower and upper substrates 100 and 300. Each of the lower and upper substrates 100 and 300 is preferably made of a transparent insulation substrate, such as glass or plastic.

Another exemplary embodiment of a display panel in accordance with the present invention is described in detail below.

In this embodiment, the lower substrate 100 of the display panel further comprises transmission and reflection gate lines 110 and 210 that alternate with each other and extend in an abscissa direction, data lines 140 that extend in an ordinate direction, transmission and reflection storage lines 120 and 220 that extend parallel to the transmission and reflection gate lines 110 and 210, a transmission TFT 150 connected to the transmission gate line 110 and the data line 140, and a reflection TFT 250 connected to the reflection gate line 210 and the data line 140.

Additionally, the lower substrate 100 further comprises a lower storage electrode 130 that is connected to the transmission TFT 150 and spaced apart from the transmission gate line 110 and the transmission storage line 120, an upper storage electrode 160 provided above the lower storage electrode 130 and connected to the transmission storage line 120, an upper electrode 260 provided above the reflection storage line 220 and connected to the reflection TFT 250, a transmission pixel electrode 180 connected to the transmission TFT 150, a reflection pixel electrode 280 partially overlapping the lower storage electrode 130 and connected to the reflection TFT 250, and a reflection film 290 provided on the reflection pixel electrode 280.

A pad that is to be connected to an external circuit is formed at an end of each of the transmission and reflection gate lines 110 and 210, the data line 140 and the transmission and reflection storage lines 120 and 220. Further, the transmission gate line 110 is preferably formed within a region covered by the reflection film 290. That is, the transmission gate line 110 is formed below the reflection film 290, as illustrated in the figures, so as to prevent the aperture ratio of the transmission pixel from being reduced by the presence of the transmission gate line 110. The reflection storage line 220 is formed in a region between the transmission and reflection gate lines 110 and 210. Further, a portion of the reflection storage line 220 is made in the form of a plate. As will be appreciated, the capacitance of the reflection storage capacitor RCst can be varied, depending on the area of the plate. The transmission storage line 120 is provided above the transmission gate line 110. Of course, the transmission storage line 120 and the transmission gate line 110 may also be arranged adjacent to each other. Preferably, a portion of the transmission storage line 120 protrudes outwardly to form a connection pad that will be connected to the upper storage electrode 160.

The transmission TFT 150 comprises a transmission gate electrode 111, a transmission source electrode 141 and a transmission drain electrode 142, and a gate insulation film 112, an active layer 113 and an ohmic contact layer 114 are provided between the transmission gate electrode 111 and the transmission source and drain electrodes 141 and 142. The reflection TFT 250 comprises a reflection gate electrode 211, a reflection source electrode 241 and a reflection drain electrode 242, and a gate insulation film 112, an active layer 113 and an ohmic contact layer 114 are provided between the reflection gate electrode 211 and the reflection source and drain electrodes 241 and 242.

The transmission and reflection gate electrodes 111 and 211 are formed in such a manner that portions of the transmission and reflection gate lines 110 and 210 protrude outwardly, and the transmission and reflection source electrodes 141 and 241 are formed in such a manner that portions of the data line 140 extend in an upper direction of the transmission and reflection gate electrodes 111 and 211. The transmission drain electrode 142 is connected to the lower storage electrode 130 and the transmission pixel electrode 180. The reflection drain electrode 242 is connected to the reflection pixel electrode 280 through the upper electrode 260.

As illustrated in the figures, the lower storage electrode 130 is formed in the shape of a plate having a selected spacing between the transmission storage line 120 and the transmission gate line 110. However, he present invention is not limited to that of the particular exemplary embodiment illustrated, but instead, the lower storage electrode 130 may be provided in a region where the aperture ratio of the transmission pixel remains unchanged. That is, the lower storage electrode 130 may be formed on an upper region of the transmission storage line 120. In this embodiment, the lower storage electrode 130 is formed in the same plane as the transmission gate line 110 and electrically connected to the transmission drain electrode 142 of the transmission TFT 150 through a contact pad.

The upper storage electrode 160 is formed above the lower storage electrode 130 such that they at least partially overlap each other. The upper storage electrode 160 is fabricated in the shape of a plate, and a portion thereof extends to a pad region of the transmission storage line 120. The transmission storage line 120 and the upper storage electrode 160 are electrically connected through a contact pad in the pad region. The capacitance of the transmission storage capacitor TCst varies according to the area of overlap of the lower and upper storage electrodes 130 and 160. As illustrated in the figures, the gate insulation film 112 is provided between the lower and upper storage electrodes 130 and 160.

The transmission pixel electrode 180 is formed above the region at which the transmission gate line 110 and the data line 140 intersect each other. A portion of the transmission pixel electrode 180 extends to a selected region of the transmission drain electrode 142 and is then connected thereto through a contact pad. That is, the transmission pixel electrode 180 is electrically connected to the lower storage electrode 130 and the transmission drain electrode 142 of the transmission TFT 150 above the lower storage electrode 130, which does not overlap the upper storage electrode 160, as illustrated in the figures.

The reflection pixel electrode 280 is formed below the region at which the reflection gate line 210 and the data line 140 intersect each other. The reflection pixel electrode 280 is connected to the upper electrode 260 through a contact pad. Further, the reflection pixel electrode 280 extends up to a region at which the transmission gate line 110 and the transmission TFT 150, as well as the lower and upper storage electrodes 130 and 160, respectively overlap each other, as illustrated in the figures.

The metallic reflection film 290 is formed on the reflection pixel electrode 280. In this embodiment, the reflection pixel electrode 280 is formed only below a region in which the reflection gate line 210 and the data line 140 intersect each other, and the reflection film 290 may extend up to the region of overlap of the lower and upper storage electrodes 130 and 160.

In the embodiment illustrated, the area that reflects external light is expanded, such that the aperture ratio of the reflection pixel is enhanced. Additionally, the upper storage electrode 160 to which the common voltage is applied is positioned between the reflection pixel electrode 280 and/or the reflection film 290 and the lower storage electrode 130, such that the signal distortion phenomenon discussed above that might otherwise occur through the expansion of the reflection pixel electrode and/or reflection film 290 is avoided.

A protection film 170 is provided between the transmission and reflection pixel electrodes 180 and 280, and the transmission and reflection gate lines 110 and 210, the data line 140, the transmission and reflection TFTs 150 and 250 and the upper and lower storage electrodes 130 and 160. A surface of the protection film in a region in which the reflection pixel electrode 280 and the reflection film are formed is fabricated with an irregular form, including concave and convex portions. The concave and convex portions function as “micro-lenses” such that the efficiency of the surface in the scattering and reflection of incident light is thereby enhanced.

A black matrix 310 for preventing light leakage and a color filter 320 for displaying colors are respectively patterned on the upper substrate 300. Further, an overcoat film 330 made of an organic material is formed on the black matrix 310 and the color filter 320, and a common electrode 340 made of a transparent conductive material is positioned on the overcoat film 330.

The lower and upper substrates 100 and 300 are spaced apart from each other by a specific “cell gap,” and an alignment film (not illustrated) is formed on each of the opposite surfaces of the lower and upper substrates 100 and 200. The alignment film is preferably made of a film capable of aligning liquid crystal molecules to be perpendicular to or parallel with the opposite surfaces of the lower and upper substrates 100 and 300. Alternatively, a film with various alignment angles may be employed.

At this stage, a cut or protruding pattern may be applied to the transmission and reflection pixel electrodes 180 and 280.

In the embodiment described above, the lower storage electrode 130 is formed in the same plane as the transmission storage line 120, the upper storage electrode 160 that is connected to the transmission storage line 120 is formed above the lower storage electrode 130, and the lower storage electrode 130 and the transmission pixel electrode 180 are electrically connected to each other, so that the transmission storage capacitor TCst is thereby formed. The transmission storage capacitor TCst thus formed can be applied to a display panel for displaying an image on a single side to increase the capacitance of a storage capacitor. That is, a lower storage electrode is provided in the same plane as a storage line, and an upper storage electrode connected to the storage line is provided on the lower storage electrode. Then, a pixel electrode partially overlapping the upper storage electrode is provided above the upper storage electrode, and the lower storage electrode and the pixel electrode are electrically connected to each other. Accordingly, a storage capacitor with a first capacitance is provided between the upper and lower storage electrodes, and a storage capacitor with a second capacitance is provided between the upper storage electrode and the pixel electrode, so that the capacitance of each of the storage capacitors is thereby increased. Of course, the various techniques described above may also be applied to a display panel adapted to display an image on only a single side thereof.

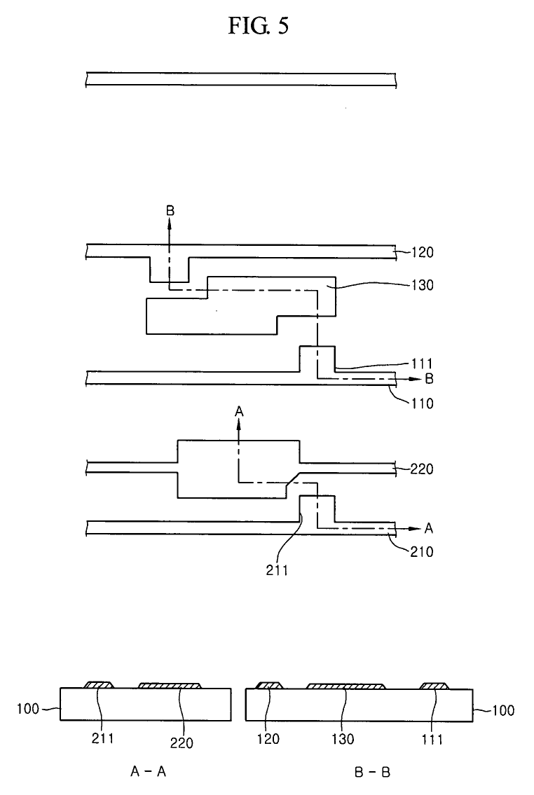

An exemplary embodiment of a method for manufacturing the dual side display panel is described below with reference to FIGS. 5 to 9, which are partial top plan and associated cross-sectional views of the panel respectively illustrating successive stages of the exemplary display panel manufacturing method.

Referring to FIG. 5, transmission and reflection gate lines 110 and 210, transmission and reflection storage lines 120 and 220, and a lower storage electrode 130 are first formed on a lower substrate 100.

A first conductive film is then formed on the lower substrate 100 through a deposition method using a CVD, PVD, sputtering or the like. Preferably, at least one of Cr, MoW, Cr/Al, Cu, Al(Nd), Mo/Al(Nd), Cr/Al(Nd) and Mo/Al/Mo is used as the first conductive film. Alternatively, the first conductive film may be made of at least any one metal comprising Al, Nd, Ag, Cr, Ti, Ta and Mo or an alloy thereof, and which may be formed as a single- or multiple-layer film. That is, the first conductive film may be formed as a double- or a triple-layer film, including a metal layer made of Cr, Ti, Ta, Mo or the like with improved physical and chemical properties, and an Al- or Ag-based metal layer with small specific electrical resistance.

After the first conductive film has been formed on the entire substrate as described above, a photoresist is applied thereto and a first photoresist mask pattern is then formed by performing a light exposure and development process using a first mask. As shown in FIG. 5, a transmission gate line 110, a transmission gate electrode 111, a lower storage electrode 130, a transmission storage line 120, a reflection gate line 210, a reflection gate electrode 211 and a reflection storage line 220 are all formed through an etching process using the first photoresist mask pattern as an etching mask.

As shown in FIG. 5, one side of the transmission storage line 120 protrudes outward in the shape of a plate. Such a protrusion of the transmission storage line 120 ensures a sufficient margin for the formation, in a subsequent process, of a contact hole for electrical connection of the transmission storage line 120 to an upper storage electrode 160 provided above the transmission storage line 120. The lower storage electrode 130 is provided above the transmission gate line 110 in the shape of an island. That is, the lower storage electrode 130 is fabricated in the shape of a plate that is electrically insulated from the transmission gate line 110 and the transmission storage line 120. Further, a central region of the reflection storage line 220 protrudes outwardly in the form of a plate. The first photoresist mask pattern is then removed by an appropriate stripping process.

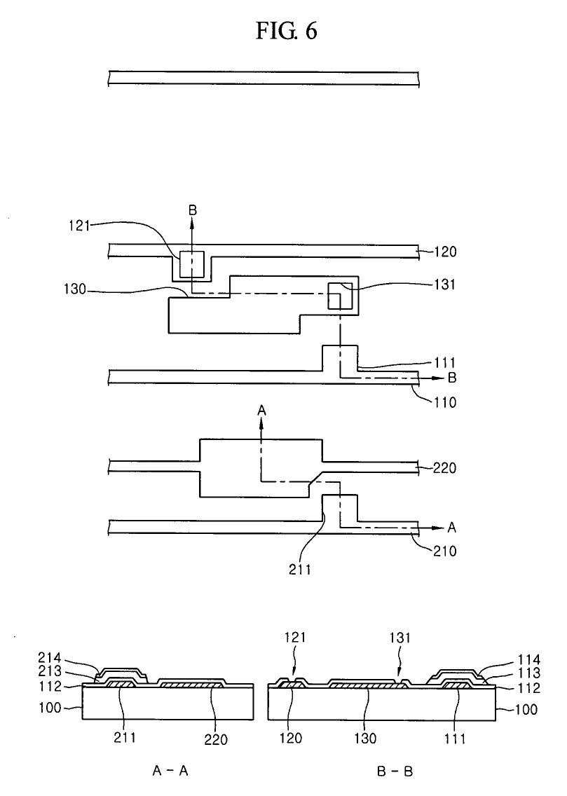

Referring to FIG. 6, a gate insulation film 112 is formed on the lower substrate 100 with the transmission and reflection gate lines 111 and 211 formed thereon, and active layers 113 and 213 and ohmic contact layers 114 and 214 are formed on the transmission and reflection gate electrodes 111 and 211, respectively. Then, first and second contact holes 121 and 131 are formed in the insulation film through which portions of the transmission storage line 120 and the lower storage electrode 130 are exposed.

To this end, the gate insulation film 112 is formed over the entire substrate through a deposition method using PECVD, sputtering or the like. In this embodiment, it is preferred that an inorganic insulation material including silicon oxide or silicon nitride be used as the gate insulation film 112. Thin films for an active layer and an ohmic contact layer are sequentially formed on the gate insulation film 112 through the aforementioned deposition method. An amorphous silicon layer is used as the thin film for an active layer, and an amorphous silicon layer doped with silicide or N-type impurities at a high concentration is used as the thin film for an ohmic contact layer. Alternatively, a thin film with a semiconductor property may be used effectively as the thin film for an active layer.

After a photoresist has been applied on the thin film for the ohmic contact layer, a second photoresist mask pattern is formed through a light exposure and development process using a second mask. The thin films for an ohmic contact layer and an active layer are removed with an etching process, and using the second photoresist mask pattern as an etching mask, to form active regions, including the ohmic contact layers 113 and 213 and the active layers 114 and 214 on the transmission and reflection electrodes 111 and 211, respectively. After the second photoresist mask pattern has been removed, a photoresist is applied over the entire substrate, and a third photoresist mask pattern is then formed through a light exposure and development process using a third mask. A portion of the gate insulation film 112 on the transmission storage line 120 and a portion of the transmission storage electrode 130 are removed through an etching process using the third photoresist mask pattern as an etching mask to form the first and second contact holes 121 and 131, respectively. Thereafter, the third photoresist mask pattern is removed.

At this point, the first contact hole 121 is preferably formed by removing the gate insulation film 112 on a protruding region of the transmission storage line 120. Further, the second contact hole 131 is preferably formed by removing the gate insulation film 112 on an end region of the lower storage electrode 130. Preferably, the first and second contact holes 121 and 131 do not overlap each other.

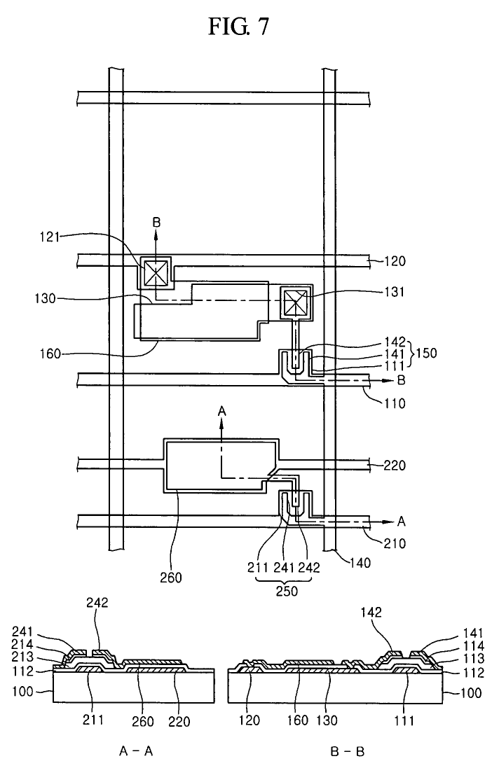

Referring to FIG. 7, a second conductive film is formed over the entire substrate structure with the active regions and the first and second contact holes 121 and 131 formed thereon and then patterned to form the data line 140, and the source and drain electrodes 141, 142 and 241, 242 are formed above the active layers 113 and 213 to form the transmission and reflection TFTs 150 and 250, respectively. Further, the upper storage electrode 160 is formed such that it partially overlaps the lower storage electrode 130 and is electrically connected to the transmission storage line 120 through the first contact hole 121. Further, an upper electrode 260 is formed such that it partially overlaps the reflection storage line 220. At this point, the upper electrode 260 is connected to the drain electrode 242 of the reflection TFT 250. Further, the drain electrode 142 of the transmission TFT 150 is connected to the lower storage electrode 130 through the second contact hole 131.

Thus, the second conductive film is formed over the entire substrate through a deposition method using CVD, PVD, sputtering or the like. At this stage, a single- or multiple-layer metal film made of at least one of Mo, Al, Cr and Ti is preferably used as the second conductive film. Of course, the second conductive film may be of the same material as the first conductive film. A photoresist is applied on the second conductive film, and a fourth photoresist mask pattern is then formed through a light exposure and development process using a fourth mask. The second conductive film is etched by an etching process using the fourth photoresist mask pattern as an etching mask to form the data line 140 perpendicular to the transmission and reflection gate lines 110 and 120, to form the source and drain electrodes 141, 142 and 241, 242 above the gate electrodes 111 and 211, respectively, and then to form the upper storage electrode 160 and the upper electrode 260. Next, the ohmic contact layers 114 and 214 exposed in regions between the source and drain electrodes 141, 142 and 241, 242 are removed through an etching process to form the transmission and reflection TFTs 150 and 250, with the respective channels thereof being made of the active layers 113 and 213 between the source and drain electrodes.

A portion of the upper storage electrode 160 overlaps the lower storage electrode 130 and the transmission storage line 120. Preferably, the upper storage electrode 160 is shaped as an island and formed in the shape of a plate, as shown in FIG. 7. Further, it is preferred that the upper electrode 260 extend from the drain electrode 242 and overlap a protruding region of the reflection storage line 220. At this point, a region of the second contact hole 131 through which a portion of the lower storage electrode 130 is exposed is preferably formed so as to be spaced apart from the upper storage electrode 160.

The second conductive film is filled into the first and second contact holes 121 and 131 to form contact plugs. The transmission storage line 120 and the upper storage electrode 160 are electrically connected to each other through the contact plug of the first contact hole 121. The lower storage electrode 130 and the drain electrode 142 of the transmission TFT 150 are electrically connected to each other through the contact plug of the second contact hole 131.

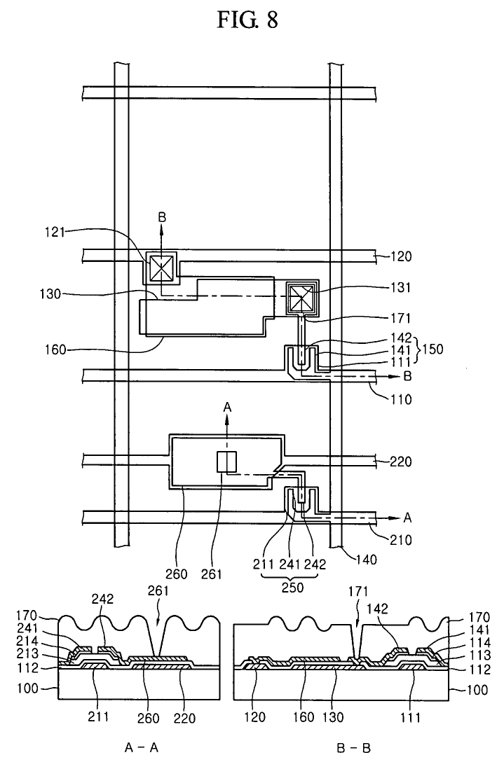

Referring to FIG. 8, a protection film 170 is formed on the lower substrate 100 having the transmission and reflection TFTs 150 and 250 formed thereon, and portions of the protection film 170 are then removed to form third and fourth contact holes 171 and 261. Further, a portion of the protection film 170 is formed to incorporate an irregular pattern, as illustrated in the cross-sectional views of FIG. 7 A-A and B-B.

An organic insulation film is formed over the entire structure as the protection film 170, and a light exposure and development process using a fifth mask are then performed. In this process, a slit mask with a slit pattern formed in a region corresponding to the region in which the irregular pattern will be formed is preferably used as the fifth mask. That is, through a light exposure and development process using a slit mask, the protection film 170 at a portion of an end region on the drain electrode 142 of the transmission TFT 150 is completely removed to form the third contact hole 171, the protection film 170 at a portion of a region on the upper electrode 260 is completely removed to form the fourth contact hole 261, and only a portion of the protection film 170 is removed at a reflection pixel electrode and a reflection film formation region, which will be fabricated in a subsequent process to form the irregular pattern. Thereafter, if the protecting film 170 is subjected to a reflow process, the irregular pattern flows such that the section of the irregular pattern is modified into a semicircular shape as shown in FIG. 8. At this point, the irregular pattern may be modified into a micro-lens shape by adjusting the reflow conditions. As shown in FIG. 8, the third contact hole 171 is preferably formed above the second contact hole 131. Further, the fourth contact hole 261 is preferably formed at a center region of the upper electrode 260. It should be understood that the protection film 170 can comprise not only an organic film, but an inorganic film as well.

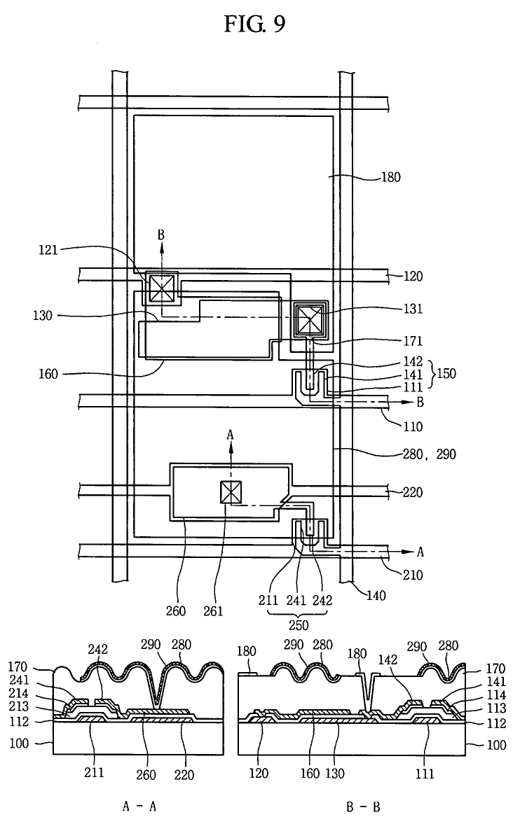

Referring to FIG. 9, a third conductive film is formed on the protection film 170 and then patterned to form the transmission and reflection pixel electrodes 180 and 280. The reflection film 290 is formed on the reflection pixel electrode 280.

First, the third conductive film is formed on the protection film 170 along a step formed therein. In this process, it is preferred that a transparent conductive film including indium tin oxide (ITO) or indium zinc oxide (IZO) be used as the third conductive film. A photoresist is applied on the third conductive film, and a sixth photoresist mask pattern is then formed by a light exposure and development process using a sixth mask. The third conductive film is removed with an etching process using the sixth photoresist mask pattern as an etching mask to form the transmission and reflection pixel electrodes 180 and 280. One end of the transmission pixel electrode 180 extends into the third contact hole 171 to connect with the drain electrode 142 of the transmission TFT 150. The reflection pixel electrode 280 is connected to the upper electrode through the fourth contact hole 261 and extends to an overlapping region of the upper and lower storage electrodes 160 and 130.

Then, a thin film of at least one of Ag, Al, Au, Cu or a respective alloy thereof is formed on the entire structure. In this process, a metal film with a reflectance of 70% or greater is preferably used as the film. A photoresist is applied on the film and a seventh photoresist mask pattern is then formed through a light exposure and development process using a seventh mask. The film is removed with an etching process using the seventh photoresist mask pattern as an etching mask to form the reflection film 290. At this time, the reflection film 290 is preferably positioned on the reflection pixel electrode 280.

An alignment film (not illustrated) is formed on the lower substrate 100 having the reflection film 290 formed thereon to fabricate the lower substrate 100 for use in a dual side display panel. Although a method of fabricating the lower substrate 100 for a dual side display panel using the seven masks has been described in the aforementioned embodiment, the present invention is not limited thereto, but may use a greater or smaller number of masks.

Next, a black matrix 310 is patterned on an upper substrate 300. The black matrix 310 shields regions corresponding to the data line 140 and the reflection gate line 210 of the lower substrate 100 to prevent light leakage from these regions. Additionally, since regions of the transmission gate line 110 and the upper and lower storage electrodes 130 and 160 for a storage capacitor are shielded by the reflection film 290, an additional black matrix is not formed in these regions. Of course, a dummy pattern (not illustrated) for preventing light leakage may be formed below the data line 140 of the lower substrate 100. In such an embodiment, the dummy pattern can be formed in the same plane as the transmission and reflection gate lines 110 and 210.

A color filter 320 is patterned on the upper substrate 300 with the black matrix 310 patterned thereon. In one embodiment, a color filter with red (R), green (G) and blue (B) colors is preferably used as the color filter 320. Then, an overcoat film 330, a common electrode 340 and the alignment film (not illustrated) are sequentially formed on the color filter 320 to fabricate the upper substrate 300 for a display panel.

The lower and upper substrate 100 and 300 are bonded together in such a manner that the transmission and reflection pixel electrodes 180 and 280 of the lower substrate 100 for a display panel faces opposite to the common electrode 340 of the upper substrate 300. A spacer is interposed between the two substrates 100 and 300 to define a space of a specific size in which a liquid crystal layer in turn is formed to fabricate the dual side display panel in accordance with the present invention.

As described in the exemplary embodiments above, a dual side display of the present invention can display images on both sides of a display panel by means of reflection pixels displaying images by reflecting light from a light source and transmission pixels displaying images by transmitting the light.

Further, a reflection film of the reflection pixel extends up to a transmission storage capacitor region of the transmission pixel such that the aperture ratio of the reflection pixel is thereby enhanced.

Furthermore, an upper storage electrode connected to a transmission storage line to which a common voltage is applied is formed between a reflection pixel electrode of the reflection pixel and/or the reflection film and a lower storage electrode of the transmission storage capacitor to prevent a signal distortion phenomenon between the reflection pixel electrode and/or the reflection film and the lower storage electrode.

By now, those of skill in this art will appreciate that many modifications, substitutions and variations can be made in and to the dual side displays and the methods for making them of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A display, comprising:
a transmission pixel having a transmission pixel capacitor and a transmission storage capacitor;
a reflection pixel having a reflection pixel capacitor and a reflection storage capacitor; and,
a reflection film formed at a region of the reflection pixel,
wherein a portion of the reflection film extends to overlap a portion of the transmission storage capacitor.

2. The display of claim 1, wherein the transmission pixel capacitor includes a transmission pixel electrode, a common electrode and a liquid crystal layer interposed between the transmission pixel and the common electrodes, and wherein the reflection pixel capacitor includes a reflection pixel electrode, a common electrode and a liquid crystal layer interposed between the reflection pixel and the common electrodes.

3. The display of claim 2, wherein the reflection film is formed on a top or a bottom surface of the reflection pixel electrode.

4. The display of claim 2, wherein the transmission storage capacitor includes a lower storage electrode connected to the transmission pixel electrode and an upper storage electrode provided above the lower storage electrode.

5. The display of claim 4, wherein the transmission pixel further includes a transmission storage line, and the transmission line and the upper storage electrode are connected to each other.

6. The display of claim 4, wherein the lower storage electrode and the transmission storage line are provided in the same plane.

7. The display of 4, wherein the reflection film overlaps a region in which the lower and upper storage electrodes overlap each other.

8. The display as claimed in claim 1, further comprising:
a transmission thin film transistor (TFT) for supplying a first image signal to the transmission pixel capacitor; and,
a reflection TFT for supplying a second image signal to the reflection pixel capacitor.

9. A display, comprising:
a plurality of transmission and reflection gate lines extending in an abscissa direction;
a plurality of data lines extending in an ordinate direction;
transmission pixels provided at some regions in which the transmission gate lines and the data lines intersect each other;
reflection pixels provided at other regions in which the reflection gate lines and the data lines intersect each other; and,
reflection films formed at the other regions of the reflection pixels, wherein
each of the transmission pixels has an associated transmission TFT connected to an associated transmission gate line and an associated data line, an associated transmission pixel capacitor connected to the associated transmission TFT, and an associated transmission storage capacitor;
each of the reflection pixels has an associated transmission TFT connected to an associated reflection gate line and an associated data line, an associated reflection pixel capacitor connected to the associated reflection TFT, and an associated reflection storage capacitor; and
a portion of each of the reflection films overlaps a portion of an associated transmission storage capacitor.

10. The display of claim 9, wherein each reflection pixel capacitor includes a reflection pixel electrode connected to a drain electrode of the associated reflection TFT, a common electrode spaced apart from the associated reflection pixel electrode, and a liquid crystal layer provided in a space between the reflection pixel electrode and the common electrode.

11. The display of claim 10, wherein each of the reflection films is formed on a top or a bottom surface of an associated reflection pixel electrode.

12. The display of claim 10, wherein each transmission gate line is provided below the associated reflection pixel electrode.

13. The display of claim 9, wherein each transmission storage capacitor includes a lower storage electrode connected to a drain electrode of the associated transmission TFT, and an upper storage electrode provided above the lower storage electrode.

14. The display of claim 9, further comprising transmission storage lines extending in parallel with the transmission gate lines.

15. The display of claim 14, wherein each transmission storage line is connected to the upper storage electrode of an associated transmission storage capacitor.

16. The display of claim 9, wherein each reflection storage capacitor includes a reflection storage line extending in parallel with the associated reflection gate line, and an upper electrode provided above the associated reflection storage line and connected to the drain electrode of the associated reflection TFT.

17. The display of claim 16, wherein the upper electrode of each reflection storage capacitor is provided below the associated reflection pixel electrode.

18. The display of claim 9, wherein the transmission and reflection gate lines are distributed in an alternating arrangement.

19. The display of claim 9, wherein each associated transmission TFT supplies a first image signal to the associated transmission pixel capacitor and the associated transmission storage capacitor, and the associated reflection TFT supplies a second image signal to the associated reflection pixel capacitor and the associated reflection storage capacitor.

20. The display of claim 9, wherein each of the transmission and reflection TFTs is turned on during a respective H/2 period.

21. The display of claim 9, wherein a light source is provided above the reflection film.

22. A display, comprising:
a lower substrate, including:
a plurality of transmission and reflection gate lines extending in an abscissa direction;
a plurality of data lines extending in an ordinate direction;
transmission and reflection storage lines extending respectively in parallel with the transmission and reflection gate lines;
transmission TFTs connected to the transmission gate lines and the data lines;
reflection TFTs connected to the reflection gate lines and the data lines;
lower storage electrodes spaced from the transmission storage lines and connected to the transmission TFTs;
upper storage electrodes provided above the lower storage electrodes and connected to the transmission storage lines;
reflection pixel electrodes provided above the reflection storage lines and connected to reflection TFTs;
reflection films formed on top or bottom surfaces of the reflection pixel electrodes and partially overlapping regions in which the lower and upper storage electrodes overlap each other; and,
transmission pixel electrode electrically connected to the lower storage electrodes through the transmission TFTs and spaced apart from the reflection pixel electrodes;
an upper substrate, including common electrodes corresponding to the transmission and reflection pixel electrodes; and,
a liquid crystal layer interposed between the lower and upper substrates.

23. The display of claim 22, wherein each transmission storage line is connected to an associated upper storage electrode through a first contact hole, and each lower storage electrode is connected to a drain electrode of an associated transmission TFT through a second contact hole.

24. The display of claim 22, wherein the reflection film is provided with an irregular form adapted to function as a plurality of micro-lenses.

25. The display of claim 22, further comprising an upper electrode connected to each reflection pixel electrode and a drain electrode of each transmission TFT between the reflection pixel electrode and each reflection storage line.

26. A method for manufacturing a display, the method comprising:
forming transmission and reflection gate lines, transmission and reflection storage lines, and a lower storage electrode on a substrate;
forming a transmission TFT connected to the transmission gate line and the lower storage electrode, an upper storage electrode overlapping the lower storage electrode and connected to the transmission storage line, a reflection TFT connected to the reflection gate line, and a data line connected to the transmission and reflection TFTs;
forming a protection film over the substrate;
forming a transmission pixel electrode connected to the lower storage electrode through the transmission TFT, and a reflection pixel electrode connected to the reflection TFT and electrically insulated from the transmission pixel electrode; and,
forming a reflection film on the reflection pixel electrode and partially overlapping a region in which the lower and upper storage electrodes overlap each other.

27. The method of claim 26, further comprising:
forming an insulation film over the entire substrate, including the transmission and reflection gate lines and the lower storage electrode thereon;
removing a portion of the insulation film to form a contact hole through which a portion of the lower storage electrode is exposed; and,
forming a drain electrode of the transmission TFT to extend into the contact hole.

28. The method of claim 27, further comprising:
removing the protection film above the contact hole to form a pixel contact hole; and,
forming the transmission pixel electrode to extend into the pixel contact hole.

29. The method of claim 26, further comprising:
forming an insulation film over the entire substrate, including the transmission and reflection gate lines and the transmission storage line thereon;
removing a portion of the insulation film to form a contact hole through which a portion of the transmission storage line is exposed; and,
forming the upper storage electrode to extend into the contact hole.

30. The method of claim 26, further comprising forming an irregular pattern on a surface of the protection film at a region in which the reflection pixel electrode or the reflection film is formed.

31. A display, comprising:
a plurality of gate lines extending in an abscissa direction;
a plurality of data lines extending in an ordinate direction;
TFTs provided at regions in which the gate and data lines intersect each other;
storage lines extending in parallel with the gate lines;
lower storage electrodes connected to the TFTs;
upper storage electrodes formed above the lower storage electrodes and connected to the storage lines;
pixel electrodes connected to the TFTs and provided at the regions in which the gate and data lines intersect each other;
common electrodes spaced apart from the pixel electrodes; and,
a liquid crystal layer provided in a space between the pixel electrodes and the common electrodes.

32. The display of claim 31, wherein the gate lines, the storage lines and the lower storage electrodes are formed in the same plane.
